(19) United States
(12) Patent Application Publication
(10) Pub. No.: US 2013/0284164 A1
(43) Pub. Date: Oct. 31, 2013

(54) Processes of Purifying Steviol Glycosides Reb C

(71) Applicants: Yong Luke Zhang, Burnaby (CA); Cunbiao Kevin Li, Burnaby (CA)

(72) Inventors: Yong Luke Zhang, Burnaby (CA); Cunbiao Kevin Li, Burnaby (CA)

(73) Assignee: GLG LIFE TECH CORPORATION, Vancouver, BC (CA)

(21) Appl. No.: 13/979,361

(22) PCT Filed: Jan. 16, 2012
(86) PCT No.: PCT/CA2012/000048

§ 371 Date: Jul. 11, 2013

(30) Foreign Application Priority Data
Jan. 14, 2011 (CN) 201110007515.0

(51) Int. Cl. C13B 50/00

(52) U.S. Cl. CPC C13B 50/00
USPC 127/30; 127/43

(57) ABSTRACT

A process for producing a natural sweetening enhancer composition comprising at least an Rebaudioside C (RC) extract, said process comprises the steps of preparing a saccharide mother liquor comprising an RC mass content of at least 15%; preparing feed liquid from about 8-25 mg/L of the mother liquor; flowing feed liquid through a porous adsorption column, having a pore size of between about 0.001 to 0.2 micron, and at a flow rate of between 25 to 35 L/m2h and at a pH of between 6 to 8; eluting RC extract with alcohol, said RC extract having a mass concentration of at least 10%; fractionally collecting eluate based on chromatographic critical point for RC extract; concentrating the RC extract and drying the extract so formed. Another process for preparing a crude RC extract which comprises the steps of preparing a saccharide mother liquor into a feedstock solution with a mass concentration of about 0.5-1%; passing the solution through an ultrafiltration membrane device at a flow rate of 25-35 L/m2h, with a molecular weight cut-off at about 5500-6500 DA and at a pH of between about 6.5-7.5, collecting and then concentrating the RC filtrate from about 55° C. to 65° C., drying solid and liquid fractions obtained from the concentrate separately to provide a crude RC extract. Extracts obtained from processes above are further refined by crystallization from water-alcohols (e.g. ethanol and methanol)-acetone mixed solvents to provide a crystalline solid comprising high content of RC.

### FIELD OF THE INVENTION

The present invention relates generally to natural sweetener compositions comprising plant glycosides and methods for producing the same from Stevia rebaudiana.

### BACKGROUND

In the food and beverage industry, there is a general preference for the consumption of sweet foods, and manufacturers and consumers commonly add sugar in the form of sucrose (table sugar), fructose or glucose to beverages, food, etc. to increase the sweet quality of the beverage or food item. Although most consumers enjoy the taste of sugar, sucrose, fructose and glucose are high calorie sweeteners. Many alternatives to these high calorie sweeteners are artificial sweeteners or sugar substitutes, which can be added as an ingredient in various food items.

Common artificial sweeteners include saccharin, aspartame, and sucralose. Unfortunately, these artificial sweeteners have been associated with negative side effects. Therefore, alternative, natural non-caloric or low-caloric or reduced caloric sweeteners have been receiving increasing demand as alternatives to the artificial sweeteners and the high calorie sweeteners comprising sucrose, fructose and glucose. Like some of the artificial sweeteners, these alternatives provide a greater sweetening effect than comparable amounts of caloric sweeteners; thus, smaller amounts of these alternatives are required to achieve a sweetness comparable to that of sugar. These alternative, natural sweeteners, however, can be expensive to produce and/or possess taste characteristics different than sugar (such as sucrose), including, in some instances, undesirable taste characteristics such as sweetness linger, delayed sweetness onset, negative mouth feels and different taste profiles, such as off-tastes, including bitter, metallic, cooling, astringent, licorice-like tastes.

Steviol glycosides are responsible for the sweet taste of the leaves of the stevia plant (Stevia rebaudiana Bertoni). These compounds range in sweetness from 40 to 300 times sweeter than sucrose. They are heat-stable, pH-stable, and do not ferment.¹ They also do not induce aglycemic response when ingested, making them attractive as natural sweeteners to diabetics and others on carbohydrate-controlled diets. ¹Brandle, Jim (2004 Aug. 19). “FAQ—Stevia, Nature's Natural Low Calorie Sweetener”. Agriculture and Agri-Food Canada. Retrieved 2006 Nov. 8

The chemical structures of the diterpene glycosides of Stevia rebaudiana Bertoni are presented in FIG. 1. The physical and sensory properties are well studied generally only for Stevioside (STV) and Rebaudioside A. The sweetness potency of Stevioside is around 210 times higher than sucrose, Rebaudioside A in between 200 and 400 times, and Rebaudioside C and Dulcoside A around 30 times. Rebaudioside A is considered to have most favorable sensory attributes of the four major steviol glycosides (see Table 1):

TABLE 1

| | | | | Optical | | | |
|---|---|---|---|---|---|---|---|
| | | | | rotation | | | |
| | | | | [a]²⁵_{D} | | | |
| | | T_{Melt}, | Mol. | (H₂O, | Solubility | Relative | Quality of |
| Name | Formula | ° C. | Weight | 1%, w/v) | in water, % | sweetness | taste |
| Steviol | C₂₀H₃₀O₃ | 212-213 | 318.45 | ND | ND | ND | Very bitter |
| Steviolmonoside | C₂₆H₄₀O₈ | ND | 480.58 | ND | ND | ND | ND |
| Stevioside | C₃₈H₆₀O₁₈ | 196-198 | 804.88 | −39.3 | 0.13 | 210 | Bitter |
| Rebaudioside A | C₄₄H₇₀O₂₃ | 242-244 | 967.01 | −20.8 | 0.80 | 200-400 | Less Bitter |
| Rebaudioside B | C₃₈H₆₀O₁₈ | 193-195 | 804.88 | −45.4 | 0.10 | 150 | Bitter |
| Rebandioside C | C₄₄H₇₀O₂₂ | 215-217 | 951.01 | −29.9 | 0.21 | 30 | Bitter |
| Rebaudioside D | C₅₀H₈₀O₂₈ | 248-249 | 1129.15 | −29.5 | 1.00 | 220 | Like sucrose |
| | | | | (ethanol) | | | |
| Rebaudioside E | C₄₄H₇₀O₂₃ | 205-207 | 967.01 | −34.2 | 1.70 | 170 | Like sucrose |
| Rebaudioside F | C₄₃H₆₈O₂₂ | ND | 936.99 | −25.5 | | ND | |
| | | | | (methanol) | | | |
| Dulcoside A | C₃₈H₆₀O₁₇ | 193-195 | 788.87 | −50.2 | 0.58 | 30 | Very bitter |
| Steviolbioside | C₃₂H₅₀O₁₃ | 188-192 | 642.73 | −34.5 | 0.03 | 90 | Unpleasant |
| Rubusoside | C₃₂H₅₀O₁₃ | ND | 642.73 | 642.73 | ND | 110 | Very bitter |

Stevia rebaudiana, after extraction and refinement is extensively used in the fields of foods, beverages, alcoholic liquor preparation, medicines, cosmetics, etc. In recent years, Stevia rebaudiana glycosides as extracts of Stevia rebaudiana have been used even more popularly as natural sweeteners and attractive alternatives to artificial sweeteners. They have become an excellent sweetening option since their caloric value is extremely low and they do not cause adverse effects to dental patients and diabetic patients. The potential market is huge.

Stevia rebaudiana glycosides mainly comprise the following nine components: Stevioside (STV), rebaudioside A (RA), rubusoside, dulcoside A (DA), rebaudioside C (RC), rebaudioside F (RF), rebaudioside D (RD), steviolbioside (STB), and rebaudioside B (RB).

The diterpene known as steviol is the aglycone of stevia's sweet glycosides, which are constructed by replacing steviol's carboxyl hydrogen atom with glucose to form an ester, and replacing the hydroxyl hydrogen with combinations of glucose and rhamnose to form an ether. The two primary compounds, stevioside and rebaudioside A, use only glucose: Stevioside has two linked glucose molecules at the hydroxyl site, whereas rebaudioside A has three, with the middle glucose of the triplet connected to the central steviol structure.

In terms of weight fraction, the four major steviol glycosides found in the stevia plant tissue are:
5-10% stevioside (STV) (250-300× of sugar)
2-12% rebaudioside A (RA)—most sweet (350-450× of sugar) and least bitter
1-2% rebaudioside C (RC)
½-1% dulcoside A. (DA)
   Rebaudioside B, D, E and steviolbioside (STB) are known to be present in minute quantities;

The tastes of these components are different from one another and can meet the demands of different consumer populations, for example, the consumers in the United States of America and Canada are fond of RA, whereas the consumers in Japan and Korea are fond of STV.

Currently, the marketed Stevia rebaudiana glycoside products are mainly RA and STV, and there are still no products mainly containing RC, therefore, the methods for extracting Stevia rebaudiana glycoside also mainly focus on the purification and refinement of RA and STV, to the exlcusion of other glycosides.

There are some very compelling reasons to maximize extraction and purification of RC. Commercial preparations of steviol glycosides such as Stevia Extract and RA possess certain drawbacks substantially limiting their usage in mainstream products. One of these disadvantages is “so-called” limited maximal response value. This is the maximal sweetness in sugar equivalents achievable by using a high intensity sweetener regardless how high the concentration of the sweetener is. For steviol glycosides this value is approx. 6-8%. This means when used “as-is” steviol glycosides cannot deliver sweetness feeling which is higher than that of 6-8% sucrose solution. Considering that majority of soft drinks contain 10-13% sucrose the usage of steviol glycosides for full sugar substitution is not possible.

It has to be noted that high intensity sweeteners' taste profile is highly dependant on the concentration and usually the higher the concentration the higher the sensation of undesirable taste components such as bitterness, licorice, lingering aftertaste. This phenomenon limits the usage of steviol glycosides further to 4-5% sucrose equivalents in order to achieve pleasant taste of a food or beverage sweetened with stevia sweeteners. While in itself not a sweetener, RC has been trialed with nutritive sweeteners and shown to enable a 20 to 25 percent reduction in calories. In other words, RC delivers flavour and sweetness enhancing properties and amplifies the sweetening capability of other glycosides.

The challenges around RC relate to its isolation and purification as compared to other glycosides and in fact few descriptions exist in literature of processes yielding high purity RC.

U.S. Pat. No. 4,353,889 describes a process of preparation of a substance referred as “Rebaudioside C”. According to the embodiment of the patent, Rebaudioside A is refluxed with strong base in aqueous methanol medium at elevated temperature. Upon completion of the reaction the mixture is cooled and acidified with sulfuric acid to yield the base hydrolysis product called “Rebaudioside C” with 99% purity. It has to be noted that the chemical formula of the compound given in the patent actually corresponds to substance currently known to art as Rebaudioside B (CAS No: 58543-17-2) hence this patent is of little use in the area of RC.

Stevia rebaudiana aqueous extract was re-crystallized from methanol-ethanol mixture and RC was recovered from obtained mixture by chromatography on silica gel (Kobayashi et al., 1977). The process employs chromatographic separation which is not suitable for application in commercial scale.

Stevia rebaudiana methanolic extract was re-crystallized from methanol and Rebaudioside C was recovered from obtained mother liquor by chromatography on silica gel (Sakamoto et al., 1977). Using chromatographic separation stage in process makes it difficult to apply in commercial scale.

Most of the existing processes of highly purified RC preparation employ techniques which are only applicable for laboratory or pilot scale production.

It is an object of the present invention to obviate or mitigate the above disadvantages.

### SUMMARY OF THE INVENTION

The present invention provides processes of selectively purifying RC from steviol glycoside compositions, compositions of such purified RC and uses thereof.

The present invention further provides a process of purifying RC from a stevia leaf extract and provides further optional downstream refining steps.

The present invention provides a process for producing a natural sweetening enhancer composition comprising at least an RC extract, said process comprising the steps of:
a) preparing a saccharide mother liquor comprising an RC mass content of at least 15%;
b) preparing feed liquid comprising from about 8-25 mg/L of the mother liquor;
c) flowing feed liquid through a porous adsorption column, having a pore size of between about 0.01 to 0.2 micron, and at a flow rate of between 25 to 35 L/m²h and at a pH of between 6 to 8;
d) eluting RC extract with alcohol, said RC extract having a mass concentration of at least 10%;
e) fractionally collecting eluate based on chromatographic critical point for RC extract;
f) concentrating the RC extract; and
g) drying the extract so formed.

The crude preparation step described above takes advantage of the selective adsorption of RC extract from Stevia rebaudiana glycoside mixture by a macro porous adsorption resin column according to its difference in parameters such as polarity, molecular weight and molecular size and the like as compared to other glycosides. Therefore, the polarity of the macro porous adsorption resin column affects the enrichment of RC to the greatest extent; then, the concentration of the feed liquid also has a significant effect on the adsorption capacity of the macro porous adsorption resin column, with either too low a concentration or too high a concentration reducing the adsorption capacity of the macro porous adsorption resin column; the average pore size and the pore volume of the resin column also affect, to some extent, the separation of individual components of Stevia rebaudiana glycoside and impurities; and the pH of the feed liquid has also a significant effect on the adsorption capacity of the resin column.

In the elution step after complete adsorption, the mass concentration of alcohol directly affects the content of rebaudioside C in the Stevia rebaudiana glycoside mixture of the eluates, since the physical and chemical properties of the individual components are similar to one another, therefore, variation in the mass concentration of alcohol will change the composition of the eluted components and affect the content of RC in the eluates. If the eluate is to be fractionally collected, the leakage points of the eluate can be determined by liquid phase chromatographic (HPLC) analysis, and then the eluate are collected.

The present invention further provides a natural sweetening enhancing composition comprising and RC extract as prepared and isolated by the steps herein.

The present invention further provides foods, beverages, nutraceuticals, functional foods, medicinal formulations, cosmetics, health products, condiments and seasonings comprising RC as prepared and isolated by the steps herein

These and other objects and advantages of the present invention will become more apparent to those skilled in the art upon reviewing the description of the preferred embodiments of the invention, in conjunction with the figures and examples. A person skilled in the art will realize that other embodiments of the invention are possible and that the details of the invention can be modified in a number of respects, all without departing from the inventive concept. Thus, the following drawings, descriptions and examples are to be regarded as illustrative in nature and not restrictive.

### BRIEF DESCRIPTION OF THE DRAWINGS

Embodiments of the present invention will now be described, by way of example only, with reference to the attached Figures, wherein:

FIG. 1 illustrates the chemical structure of RC; and

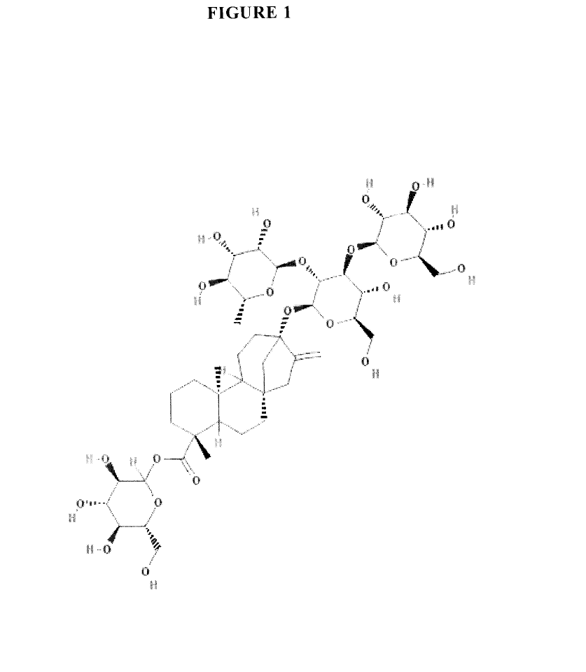

FIG. 2 is a flow diagram of the extraction process for extracting a primary extract of steviol glycosides from the leaves of Stevia rebaudiana to yield a mother liquor;

### DETAILED DESCRIPTION OF THE INVENTION

A detailed description of one or more embodiments of the invention is provided below along with accompanying figures that illustrate the principles of the invention. As such this detailed description illustrates the invention by way of example and not by way of limitation. The description will clearly enable one skilled in the art to make and use the invention, and describes several embodiments, adaptations, variations and alternatives and uses of the invention, including what we presently believe is the best mode for carrying out the invention. It is to be clearly understood that routine variations and adaptations can be made to the invention as described, and such variations and adaptations squarely fall within the spirit and scope of the invention.

In other words, the invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the present disclosure and claims (if any), the word “comprising” and its derivatives including “comprises” and “comprise” include each of the stated integers or elements but does not exclude the inclusion of one or more further integers or elements. The term “process” may be used interchangeably with “method”, as referring to the steps of purification described and claimed herein. The term Rebaudioside C may be used interchangeably with RC (or Reb C). The term “column” may refer to single or plural columns.

As used herein, the term “mother liquor of sugar” or “mother liquor” in the purification processes refers to a Stevia rebaudiana glycoside solution containing with respect to at least an RC a mass content of about 10-15%, which can be prepared from the extract of Stevia rebaudiana or other Stevia rebaudiana glycoside products.

For clarity, it is to be noted that “steviol glycosides” have been referred to as stevia, stevioside, and stevia glycoside in the scientific literature. Generally, the term, steviol glycosides has been adopted for the family of steviol derivatives with sweetness properties that are derived from the stevia plant. More recently, the term, stevia, is used more narrowly to describe the plant or crude extracts of the plant, while stevioside is the common name for one of the specific glycosides that is extracted from stevia leaves. Stevioside is distinct from steviolbioside.

As used herein, the term “about” in connection with a measured quantity, refers to the normal variations in that measured quantity, as expected by a skilled artisan making the measurement and exercising a level of care commensurate with the objective of measurement.

As used herein, the term dalton (Da or D) refers to an alternate name for the unified atomic mass unit (u or amu).

Within the scope of the invention, the mother liquor which provides a required high content level of RC is prepared from the crystallization of stevia primary extract (SPE). With the purification process as described herein (which is the crystallization of stevia extract) RC in the mother liquor is enriched. The mother liquor, as preferably used herein, is a by-product from Reb A, and STV purification (crystallization and recrystallization) process. Accordingly, after purifying out (by these known techniques) the major components (such as RA and STV), the percentage of minor components will be increased. In other words, the mother liquor which is the starting material of the present invention for RC processing is a usually discarded by-product of conventional stevia leaf processing.

Natural sweetener compositions that have a taste profile comparable to sugar are desired. Further, a composition that is not prohibitively expensive to produce is preferred. Such a composition can be added, for example, to beverages and food products to satisfy consumers looking for a sweet taste. There is provided herein a process to selectively extract particular steviol glycosides in order to customize sweetening goals

The genus Stevia consists of about 240 species of plants native to South America, Central America, and Mexico, with several species found as far north as Arizona, New Mexico, and Texas. They were first researched by Spanish botanist and physician Petrus Jacobus Stevus (Pedro Jaime Esteve), from whose surname originates the Latinized word stevia.

Steviol glycosides have highly effective sweet taste properties. In fact, these compounds range in sweetness up to 380 times sweeter than sucrose. They are safe, non-toxic heat-stable, pH-stable, and do not ferment making them very commercially workable in the manufacture of foods and beverages. Furthermore, they do not induce a glycemic response when ingested (they have zero calories, zero carbohydrates and a zero glycemic index), making them extremely attractive as natural sweeteners to diabetics, those on carbohydrate-controlled diets and to anyone seeking healthy alternatives. The glycemic index, or GI, measures how fast a food will raise blood glucose level. Choosing foods that produce zero fluctuations in blood glucose is an important component for long-term health and reducing risk of heart disease and diabetes. As such, use of the natural sweetener compositions of the present invention has enormous advantages over cane, beet and other sugars.

During the extraction process, as increasing levels of purity of glycosides are produced, the costs associated with achieving such increasing levels of purity also increases. Those skilled in the art will understand that purifying steviol glycoside extracts to higher levels of purity, especially purity levels greater than 95%, can be very costly, which can be limiting on the use of these steviol glycosides in sweetener compositions. This is the problem addressed herein with respect to RC. It is possible to employ sweetening-type steviol glycosides, such as Reb A, at lower purities (and lower production costs), if pure and concentrated RC, prepared in accordance with the present invention is combined therewith as a sweetening “amplifier”.

Typically, steviol glycosides are obtained by extracting leaves of Stevia rebaudiana Bertoni with hot water or alcohols (ethanol or methanol); the obtained extract is a dark particulate solution containing all the active principles plus leaf pigments, soluble polysaccharides, and other impurities. Some processes remove the “grease” from the leaves with solvents such as chloroform or hexane before extraction occurs. There are dozens of extraction patents for the isotation of steviol glycosides, such processes often being categorized the extraction patents into those based on solvent, solvent plus a decolorizing agent, adsorption and column chromatography, ion exchange resin, and selective precipitation of individual glycosides. Methods using ultra filtration, metallic ions, supercritical fluid extraction with CO₂ and extract clarification with zeolite are found within the body of more recent patents.

At the 68th Joint Expert Committee on Food Additives (“JECFA”) meeting in 2007, steviol glycosides were defined as the products obtained from the leaves of Stevia rebaudiana Bertoni. As cited by JECFA, the typical manufacture starts with extracting leaves with hot water and the aqueous extract is passed through an adsorption resin to trap and concentrate the component steviol glycosides. The resin is washed with methanol to release the glycosides and the product is recrystallized with methanol. Ion-exchange resins may be used in the purification process. The final product is commonly spray-dried. Table 2 (at the conclusion of the disclosure) provides a product monograph of steviol glycosides, including chemical names, structures, methods of assay and sample chromatogram showing elution times of nine major glycosides.

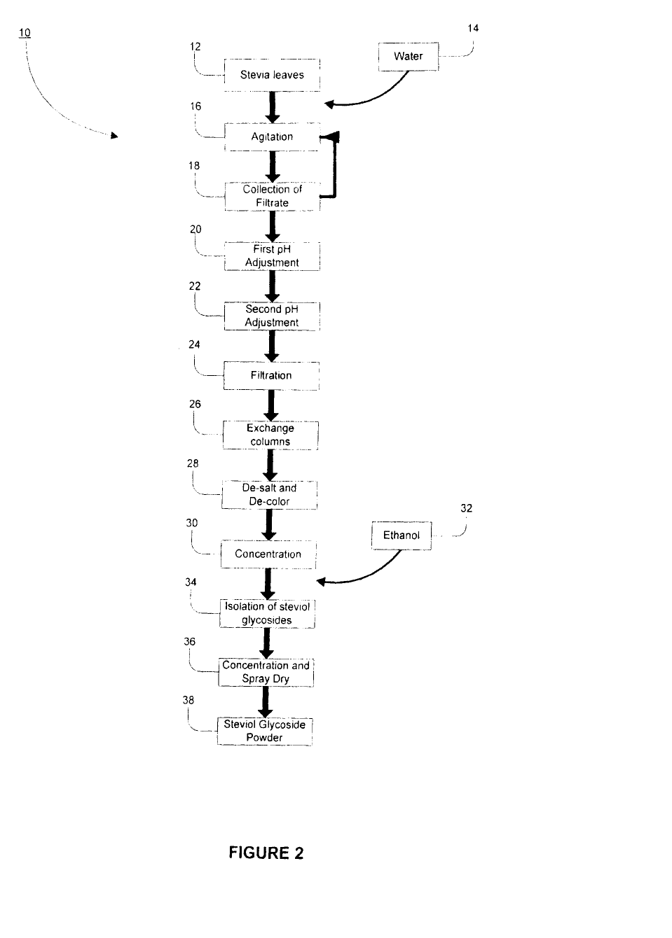

The following provides preferred steps of an extraction process used to isolate glycoside extracts (yielding mother liquor) from Stevia leaves. As shown in FIG. 2, the glycoside extracts are isolated using the following steps. The Stevia leaves (12) are dried and the dried stevia leaves are agitated (16) in a volume of water (14) to release the sweet glycosides from the dried stevia leaves. Preferably, the sweet glycosides are released from the dried leaves using between about 1 volume to about 15 volumes of water. Even more preferably, the sweet glycosides are released from the dried leaves using about 12 volumes of water. The water-leaves mixture is agitated (16) for a period of time between about 10 minutes and about 1 hour, more preferably for a period of time between about 25 minutes and about 35 minutes. Following the agitation (16), the water-leaves mixture is drained and the filtrate collected (18). The cycle of agitation (16) and the collection of filtrate (18) is repeated for a total of about five cycles. Over the course of the five cycles, the water-leaves mixture is agitated for a total period of time between about 1 hour and about 5 hours, more preferably for a total period of time between about 2 hours and about 3 hours.

In one embodiment, for each agitation/collection cycle, the water-leaves mixture is agitated (16) in an environment having a temperature between about 5° C. and about 50° C., more preferably at a temperature between about 20° C. and about 30° C. Following the completion of the agitation/collection cycles, the pH of the water-leaves mixture is first adjusted to about pH 8.0 (20). The pH adjusted water/leaves mixture is then allowed to stand for a period of time between about 30 minutes and about two hours. The pH of the water-leaves mixture is then adjusted a second time (22) to about pH 7.0. The water-leaves mixture is subsequently filtered (24) to obtain an aqueous filtrate. The aqueous filtrate is then applied to ion exchange columns (26) to purify and decontaminate the aqueous filtrate. A person skilled in the art would understand that other methods may also be used to purify and decontaminate the aqueous filtrate. The aqueous filtrate is subsequently de-salted and de-colorized (28) and concentrated (30) using adsorption resin beds. A person skilled in the art would understand that other methods may also be used to concentrate the aqueous filtrate. A filtrate solution containing concentrated steviol glycosides is released from the adsorption resin beds (34) by rinsing the adsorption resin beds with ethanol (32), preferably about 70% ethanol (32).

### Reb C:

The present invention provides a Stevia rebaudiana glycoside prepared using the above-mentioned purification method (starting with the mother liquor, as defined herein) and in which the mass content of RC reaches, at a first stage, to at least about 30%, more preferably above 40%. Further concentration and purification steps (further refining) as also described herein, significantly increase the concentration of RC in the final purified composition to at least about 80%, more preferably from about 85-95%.

The present invention preferably provides a process for producing the natural sweetening enhancer composition comprising at least RC extract, said process comprising the steps of:
a) preparing a saccharide mother liquor comprising an RC mass content of at least 15%;
b) preparing feed liquid comprising at least from 10-20 mg/L of the mother liquor;
c) flowing feed liquid through porous adsorption columns, having a pore size of between about 0.01 to 0.2 micron, and at a flow rate of between 25 to 35 L/m²h and at a pH of between 6 to 8 to yield an RC solution;
d) eluting RC solution with alcohol, said RC solution having a mass concentration of at least 10% to produce an eluate;
e) fractionally collecting the eluate based on chromatographic critical point for RC extract;
f) concentrating the crude RC extract at a temperature of between about 50-70° C.; and
g) drying the crude RC extract so formed.

Preferably, the method for purifying RC comprises a first step of preparing a crude RC extract which comprises the steps of preparing a saccharide mother liquor into a feedstock solution with a mass concentration of about 0.5%-1%, passing the solution through an ultra filtration membrane device at a flow rate of about 25-35 L/m²h. the molecular weight cut-off of said ultra filtration membrane being about 5500-6500 DA, with a pH being controlled at about 6.5-7.5, to produce an RC solution, concentrating the RC solution at a temperature of from about 55° C. to 65° C., drying the resulting solid and liquid respectively, and thereby obtaining a crude RC extract.

The saccharide mother liquor in the purification method mentioned above refers to a solution with RC mass content of at least 15% and more preferably about 15-20%, which can be made of the direct extract from Stevia rebaudiana or other rebaudioside products.

In the above-mentioned method for purifying RC, said ultra filtration membrane is a polyvinylidene difluoride (PVDF) wound-type membrane, although other membranes may be acceptably used, if they achieve the same functional result. In the above-mentioned method for purifying RC, the pore size of said ultra filtration membrane is preferably from about 0.01-0.2 μm.

In the above-mentioned method for purifying RC, the surface layer thickness of said ultra filtration membrane is preferably from about 0.03 to 0.06 μm, more preferably about 0.05 μm, and the under layer thickness thereof is preferably from about 250-350 μm, more preferably 300 μm.

In the above-mentioned method for purifying RC, the molecular weight cut-off of said ultra filtration membrane is preferably from about 5500-6500 DA, more preferably about 6000 DA.

In the above-mentioned method for purifying RC, the flow rate of said feedstock solution is preferably about 25-35 L/m²h.

In the above-mentioned method for purifying RC, said solid mass percent after concentration is preferably about 30-35%, more preferably about 40%-45%.

In the extract produced by the method so described, the RC mass content reaches over 30%.

Based on the difference in molecular weights, each constituent of the rebaudioside mixture is ultra filtrated through the ultra filtrate membrane by the crude preparation steps mentioned above, which causes that a material which has a higher volume than the Millipore size on the membrane surface in the feedstock solution is intercepted on the input liquid side of the membrane, and thus it becomes a concentrated solution; therefore, the purification, separation and concentration of the feedstock solution are achieved, thereby increasing the contents of the total rebaudioside and RC. The molecular weight cut-off of the ultra filtration membrane has the greatest effect on the increase of total glycoside and RC contents within the scope of the invention. In addition, the “feedstock solution” concentration has a key effect on the molecular retention of the ultra filtration membrane, with either too low or too high a concentration reducing the retention capability of the ultra filtration membrane. Furthermore, it has been found that the pH value of the feedstock solution has a great effect on the ultra filtration of the ultra filtration membrane, while the pore size, the surface layer thickness, and the under layer thickness of the ultra filtration membrane have an effect on the ultra filtration of RC and impurities.

In the above-mentioned method for purifying RC, said crude RC may also preferably be subjected to a further refining process, and said refining process including the following steps:
a) preparing a mixed solvent of an alcohol-ketone solvent solution;
b) heating the mixed solvent;
c) mixing crude RC into the mixed solvent, with a mass ratio between the mixed solvent and said crude RC of preferably about 2.0-4.0:1. more preferably 2.5-3.5:1;
d) dissolving the crude RC in the mixed solvent and forming a mixed solution,
e) cooling down said mixed solution to an ambient temperature;
f) letting the mixed solution stand with stirring at intervals; and
g) after standing, performing a solid-liquid separation, drying the resulting solid and liquid respectively, and obtaining a refined RC.

In the above-mentioned refining steps, due to the very close polarity of each component of Steviol glycosides, the polarity of the solvent must be formulated accurately; each slight difference in the polarity of solvent can affect the dissolubility of each component in the solvent; so the solvent ratio is very critical, which not only makes each component and impurity thoroughly dissolve into the solvent, but also causes the fastest decrease of dissolubility of the target product and the fastest precipitation, after cooling down; additionally, an accurate dissolution temperature can not only facilitate the thorough dissolution of the target product RC, but also benefit the temperature control during the industrial process. During the cooling period, the cooling time also has an effect on the crystallization solution, and a target within the parameters defined here in preferred, neither too fast nor too slow with such ideal speed facilitating the increase of purity of RC after crystallization.

In the above mentioned method for further purifying RC, the alcohol-ketone solvent solution comprises ethanol, methanol and acetone, more preferably 85%±2% of ethanol, 70%±2% of methanol, and 85%±2% of acetone at a ratio of 3:2:1. In the above mentioned method for purifying RC, the mixed solvent is heating to preferably 50-65° C. In the above mentioned method for purifying RC, the cooling down said mixed solution to an ambient temperature takes from 10-15 minutes. In the above mentioned method for purifying RC, solid-liquid separation if performed preferably after 40-50 hrs of standing.

In the above-mentioned method for further purifying RC, the mixed solvent is cooled down to an ambient temperature over about 10-15 minutes, ideally around 12 minutes. In the above-mentioned method for purifying RC, the mixed solvent is preferably heated to 60° C.

In the above-mentioned method for further purifying RC, said drying of the resulting solid and liquid through solid-liquid separation respectively includes the following steps: dissolving the solid into a solution with a mass concentration of 20%±2% by the addition of non-brine water, and then concentrating the solution into a concentration of 40%±2%, then spray drying the concentrated solution to obtain a product; evaporating the alcohol-acetone mixed solvent (preferably methanol, ethanol, and acetone) and excessive water from the liquid, adjusting the mass concentration of the liquid to 40%±2%, and drying the solution to obtain a product.

In the above-mentioned method for further purifying RC, the stirring is preferably done every 8-12 hours for 4-7 minutes each time during the standing period.

The present invention has the following advantages as compared with the prior art in that the method produces a steviol glycoside product with a RC content of more than 30% (in crude extract) and more than 85% (in final refined extract), and thereby provides RC as a pure sweetening enhancer, with wide commercial applicability.

Regarding elution to remove the desired glycoside, HPLC (High Performance Liquid Chromatography) is preferably used to check the glycosides (RC) content in the eluate and to remove selected glycoside (RC) based on its known elution profile.

The present process comprises:
1) a first purification process to yield a crude RC extract having at least about 30% solid mass content being RC and wherein starting material for this first purification phase is a saccharide mother liquor having an RC mass content of at least 15%;
2) a second purification or refinement process to yield an RC extract having at least 85% solid mass content being RC.

In this regards, there are four important preferred features and advantages of the invention:
the mother liquor starting material is preferably a co-product from the purification of Rebaudioside A95/97 and STV95/97, and wherein mother liquor has an RC mass content of at least 15%, such being highly preferred to achieve the RC downstream purities;
the mother liquor preferably is passed through ultra filtration membrane systems to remove some impurities to yield pure mother liquor
a resin column(s) chromatographic system is preferably used to further purify the mother liquor to yield a crude RC extract having at least about 30% solid mass content of RC, such being highly preferred to achieve the RC downstream purities
crystallization technology with preferred solvent systems are used to purify the crude RC extract to a high degree of purity, preferably and ideally to about 85 to 95% thereby yielding a final, high purity RC extract composition

### Uses:

The final, high purity RC extract composition of the present invention may be used as a sweetening and flavouring enhancing agent with a variety of other sweeteners, both natural and artificial.

Although the present invention should not be limited for defined by any one particular relative amount or ratio of the purified RC to be used, it can be noted that generally, RC can be combined preferably, but not exclusively, with RA, STV, RB and RD. In this regard, the other steviol glycoside (one or more in combination) which can be blended with RC, as purified in accordance with the present invention, is referred to herein as the “Stevia Sweetening Agent”

The ratio of the present RC extract to the Stevia Sweetening Agent is preferably between about 12:1 and about 1:12. An even more preferred ratio for the ratio between RC extract and Stevia Sweetening Agent is between about 9:1 and about 1:9. A further preferred ratio for the ratio between RC extract and Stevia Sweetening Agent is between about 5:1 and about 1:5. Another preferred ratio for the ratio between RC extract and Stevia Sweetening Agent is between about 4:1 and about 1:4. Another preferred ratio for the ratio between RC extract and Stevia Sweetening Agent is between about 3:1 and about 1:3. Another preferred ratio for the ratio between RC extract and Stevia Sweetening Agent is between about 2:1 and about 1:2.

In one aspect, the sweetener enhancer compositions of the present invention (comprising RC prepared by the processes described herein, along with one or more Stevia glycosides) may be used in the preparation of various food products, beverages, medicinal formulations, chemical industrial products, among others. Exemplary applications/uses for the sweetener compositions include, but are not limited to: (a) food products, including canned food, preserved fruits, pre-prepared foods, soups, (b) beverages, including coffee, cocoa, juice, carbonated drinks, sour milk beverages, yogurt beverages, meal replacement beverages, and alcoholic drinks, such as brandy, whisky, vodka and wine; (c) grain-based goods—for example, bread and pastas, cookies, pastries, whether these goods are cooked, baked or otherwise processed; (d) fat-based products—such as margarines, spreads (dairy and non-dairy), peanut butter, peanut spreads, and mayonnaise; (d) Confectioneries—such as chocolate, candies, toffee, chewing gum, desserts, non-dairy toppings (for example Cool Whip®), sorbets, dairy and non-dairy shakes, icings and other fillings, (e) drug and medicinal formulations, particularly in coatings and flavourings; (f) cosmetics and health applications, such as for sweetening toothpaste; and (g) seasonings for various food products, such as soy sauce, soy sauce powder, soy paste, soy paste powder, catsup, marinade, steak sauce, dressings, mayonnaise, vinegar, powdered vinegar, frozen-desserts, meat products, fish-meat products, potato salad, bottled and canned foods, fruit and vegetables.

The natural sweetener enhancer compositions of the present invention may be formulated into premixes and sachets. Such premixes may then be added to a wide variety of foods, beverages and nutraceuticals. The purified natural sweetener compositions may, in one preferred form, be table top sweeteners.

In an alternative embodiment, the sweetener enhancer compositions of the present invention additionally comprise a secondary sweetening component. The secondary sweetening component is preferably selected from the group consisting of sucrose, erythritol, fructose, glucose, maltose, lactose, corn syrup (preferably high fructose), xylitol, sorbitol, or other sugar alcohols, inulin, miraculin, monetin, thaumatin and combinations thereof, and also non-natural sweeteners such as aspartame, neotame, saccharin, sucralose and combinations thereof. Preferably, for a 50% reduced calorie table top product, the ratio of a secondary sweetening component (most preferably sucrose) to the blends is preferably about 24.7:1. Such a natural sweetener composition can easily be added to food products and beverages, or can be used as a table top sweetener. The ratio of secondary sweetening component to the blends is more preferably between about 5:1 and 1:1. The natural sweetener enhancer compositions may be used alone or in combination with other secondary sweeteners, as described herein, and/or with one or more organic and amino acids, flavours and/or coloring agents.

While the forms of processes and compositions described herein constitute preferred embodiments of this invention, it is to be understood that the invention is not limited to these precise forms. As will be apparent to those skilled in the art, the various embodiments described above can be combined to provide further embodiments. Aspects of the present composition, method and process (including specific components thereof) can be modified, if necessary, to best employ the systems, methods, nodes and components and concepts of the invention. These aspects are considered fully within the scope of the invention as claimed. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

The following examples illustrate preferred embodiments of the present invention.

### EXAMPLES

### Example 1

### Extraction of Steviol Glycosides from Stevia rebaudiana Leaves-Preparation of Mother Liquor

One kg of the stevia leaves known to have a high content of Rebaudioside A were steeped with 2 kg of room temperature water having a pH of 7.3 in an agitation centrifuge. The leaves were agitated for 0.5 hour. The sweet water was filtered, the filtrate collected and the process repeated for a total of 5 steep/separation cycles. The pH of the sweet water filtrate solution was adjusted to pH 8.0 with approximately 30 grams of calcium hydroxide. After a rest time of about 1 hour, 50 grams of FeCl₃ was added to the sweet water filtrate solution to further adjust the pH to 7.0. The solution was filtered and the resulting filtrate had a transmittance of about 68±2% at 325 nm. The filtrate flows through the resin bed, and the glycosides was eluted from the resin bed by using 75% of ethanol. The eluate was concentrated to 45-50% of solid content, and then was vacuum dried. The weight of dried elute is 120 g. This dried eluate is called stevia extract or Stevia Primary Extract (SPE).

The mother liquor which content high level of RB, RD and steviolbioside (STB) is prepared from the crystallization of stevia primary extract (SPE). With the purification process (which is the crystallization of stevia extract) of RA, STV, the concentration of RC in the mother liquor is enriched. With the purification process of RC, the concentration of RB, RD and steviolbioside (STB) in the mother liquor is enriched

### Example 2

A saccharide mother liquor was taken, and its RC content was measured as 17.73%, and the total glycoside content 62.58% via liquid chromatography (HPLC) analysis. The saccharide mother liquor was prepared into a feedstock solution with a mass concentration of 0.5%; 300 L of feedstock solution was taken and passed through an ultra filtration membrane device manufactured by the GE company, USA, at a flow rate of 25-35 L/m²h; when the feedstock solution passed through the ultra filtration membrane, a retention was performed based on the different molecular weight of each constituent, and the ultra filtration pH was 7.2. The concentrated solution was cut off in section with 5 L as a unit, and the RC content was detected using a liquid chromatography (HPLC) analysis. 1% of the saccharide mother liquor was cut-off by an 8000 molecular weight membrane; when the saccharide mother liquor was treated with a 5500-6500 membrane, it was found that a 6000 membrane can enrich 85%-90% saccharide into a concentrated solution, but for the concentrated solution which only can be obtained by the 6000 membrane, its impurity removal effect was not obvious (i.e., the impurity and glycoside were cut-off and concentrated by the 6000 membrane); therefore, the total glycosides content can be improved by obtaining a concentrated solution through the use of the 6000 membrane, then adding 10-30 times water volume to dilute the concentrated solution, and removing the impurity from the concentrated solution. The parameter comparisons between the content of each main component of steviol glycosides in 10 L, 15 L, and 20 L of concentrated solution and the contents of the concentrated solution and the feedstock solution after washing with water are shown in the following table:

| | | | | | | The |
|---|---|---|---|---|---|---|
| | | | | The | The total | increase of |
| The object of | | | | increase of | content of | total |
| chromatographic (HPLC) | | | | RC | glycoside | glycoside |
| analysis | STV % | RC % | RA % | content % | % | content % |
| feedstock | 19.13 | 17.73 | 22.2 | / | 62.58 | / |
| 20 L of concentrated | 20.44 | 26.09 | 26.24 | 8.36 | 76.09 | 13.51 |
| solution | | | | | | |
| 15 L of concentrated | 21.14 | 28.18 | 27.93 | 10.45 | 80.99 | 18.41 |
| solution | | | | | | |
| 10 L of concentrated | 20.92 | 27.01 | 26.89 | 9.28 | 77.65 | 15.07 |
| solution | | | | | | |
| 15 L of concentrated | 21.13 | 29.36 | 29.69 | 11.63 | 83.26 | 20.68 |
| solution washed with 15 | | | | | | |
| times volume of water | | | | | | |
| 15 L of concentrated | 20.98 | 28.56 | 28.01 | 10.83 | 81.21 | 18.63 |
| solution washed with 30 | | | | | | |
| times volume of water | | | | | | |

It can be seen from the above table that the RC contents in the concentrated solution were all above 26%, and the total glycoside contents were all above 76%. With the use of a 6000 membrane, the glycoside content in the concentrated solution can be increased by 13%-20%, and the RC content by 8%-10%. After the 15 L of concentrated solution was washed with 15 times volume of water, its RC content could even reach 29.36%, and compared with the RC content in the feedstock solution, the RC content was also increased by 11.63%, and the total glycoside content was increased by 20.68% as compared with the total glycoside content in the feedstock solution. After the 15 L of concentrated solution was washed with 30 times volume of water, its RC content was increased by more than 10%, and the total glycoside content was increased by more than 10%; it could be clearly seen that the increase of the 15 L of concentrated solution dialyzed with 15 times volume of water was the biggest, in teens of either RC or the total glycoside content. The total glycoside content was increased by 20% when dialyzing with 15 times (15 times of concentrated solution volume) volume of water; the total glycoside content was reduced when too much water was added.

After being washed with 15 times volume of water, the 15 L of cut-off concentrated solution was concentrated at 55° C.; after that, the solid content was controlled at 40%, and the resulting solid and liquid were dried separately to obtain a crude rebaudioside C; the RC content of the crude rebaudioside was measured as 33.16%.

After being washed with 30 times volume of water, the 15 L of cut-off concentrated solution was concentrated at 65° C.; after that, the solid content was controlled at 45%, and the resulting solid and liquid were dried respectively to obtain a crude rebaudioside; the RC content in the crude RC was measured as 30.01%.

### Example 3

10 kilograms of the crude RC with a RC content of 30.16% prepared in example 2 were taken and mixed thoroughly with 25 kilograms of 87% of ethanol, 68% of methanol and 87% of acetone at a ratio of 3:2:1, to prepare a mixed solvent; after complete dissolution at 50° C., the solvent was rapidly cooled down to an ambient temperature over 10 minutes, and the mixture was stirred for 4 minutes every 8 hours; after standing for 40 hours, the dissolved mixture was subjected to a solid-liquid separation, and a solution of the solid filtered out was adjusted to a concentration of 22% with the addition of non-saline water; the solution was concentrated to 38% and dried so as to obtain 3.0 kilograms of a refined rebaudioside C; the rebaudioside C (RC) content in the refined rebaudioside C was 85.43%; the methanol, ethanol, acetone and excessive water were evaporated from the liquid which was obtained through a solid-liquid separation; the aqueous rebaudioside C solution concentration was adjusted to 40%, and after drying, 5.8 kilograms of the refined rebaudioside C was obtained, so that the total recovery of rebaudioside C was 88.0%.

### Example 4

10 kilograms of crude rebaudioside C with an RC content of 30.16% prepared in example 2 were taken and mixed thoroughly with 30 kilograms of 83% of ethanol, 72% of methanol and 85% of acetone at a ratio of 3:2:1, to prepare a mixed solvent; after complete dissolution at 60° C., the solvent was rapidly cooled down to an ambient temperature over 13 minutes, and the mixture was stirred for 6 minutes every 10 hours; after standing for 45 hours, the dissolved mixture was subjected to a solid-liquid separation through a frame filter press, and a solution of the solid filtered out was adjusted to a concentration 20% with the addition of non-saline water; the solution was concentrated to 42% and dried so as to obtain 2.6 kilograms of a refined rebaudioside; the rebaudioside C (RC) content in the refined rebaudioside C was 85.96%; the ethanol and excessive water were evaporated from the liquid which was obtained through a solid-liquid separation, the aqueous rebaudioside C solution concentration was adjusted to 42%, and after drying, 5.9 kilograms of the refined rebaudioside C were obtained; the total recovery of rebaudioside C was 85.0%.

### Example 5

10 kilograms of rebaudioside C powder with a rebaudioside C (RC) content of 30.16% were selected and mixed thoroughly with 35 kilograms of 85% of ethanol, 70% of methanol and 83% of acetone at a ratio of 3:2:1, to prepare a mixed solvent; after complete dissolution at 65° C., the solvent was rapidly cooled down to an ambient temperature over 12 minutes, and the mixture was stirred for 7 minutes every 12 hours; after standing for 50 hours, the dissolved mixture was subjected to a solid-liquid separation through a frame filter press, and a solution of the solid filtered out was adjusted to a concentration of 18% with the addition of non-saline water; the solution was concentrated at 45% and dried so as to obtain 3.3 kilograms of a refined rebaudioside C; the rebaudioside C (RC) content in the refined rebaudioside C was 86.68%; the ethanol and excessive water were evaporated from the liquid which was obtained through the solid-liquid separation; the aqueous rebaudioside C solution concentration was adjusted to 42%, and after drying, 5.7 kilograms of refined rebaudioside C were obtained; the total recovery of rebaudioside C was 90%.

It can be seen from the above-mentioned examples that after the crude preparation, the RC content of rebaudioside C could reach over 30%, and after the refined step, it was over 85%, and the rebaudioside C recovery more than 85%, with a high purity.

The above-mentioned rebaudioside C can be in the shape of powder or crystallization; the surrounding vapor heating indicated in the present invention refers to heating by filling the vapor into the annular space between a small storage tank and a big storage tank which surrounded the small one; drying can be any drying means in the prior art which is suitable for the present invention, such as vacuum drying.

1. A process for producing a natural sweetening enhancer composition comprising Rebaudioside C (RC), said process comprising the steps of:
a) preparing a saccharide mother liquor comprising an RC mass content of at least 15%;
b) preparing feed liquid comprising from about 8-25mg/L of the mother liquor;
c) flowing feed liquid through a porous adsorption column, having a pore size of between about 0.01 to 0.2 micron, and at a flow rate of between 25 to 35 L/m2h and at a pH of between 6 to 8;
d) eluting RC extract with alcohol, said RC extract having a mass concentration of at least 10%;
e) fractionally collecting eluate based on chromatographic critical point for RC extract;
concentrating the RC extract; and
g) drying the extract so formed.

2. The process of claim 1 wherein the mother liquor is formed via the steps of
a) drying Stevia leaves;
b) mixing and agitating the dried Stevia leaves with water to produce a water-leaves mixture; and
c) filtering the water-leaves mixture to obtain an aqueous filtrate.

3. The process of claim 2 wherein the mixture and agitation of the dried Stevia leaves with water is conducted with about 1 volume of water to about 15 volumes of water.

4. The process of claim 2, wherein the mixture and agitation of the dried Stevia leaves with water is conducted for about one hour to about five hours at about 5° C. to about 50° C.

5. The process of claim 1 wherein the feed liquid comprises at least from 10-20 mg/L of the mother liquor.

6. The process of claim 1 wherein the crude RC extract is concentrated at a temperature of between about 50-70° C.

7. A process of preparing a crude RC extract which comprises the steps of:
a) preparing a saccharide mother liquor into a feedstock solution with a mass concentration of about 0.5%-1%;
b) passing the solution through an ultrafiltration membrane device at a flow rate of about 25-35 L/m2h, with the molecular weight cut-off of said ultrafiltration membrane being about 5500-6500 DA and at a pH of between about 6.5-7.5 to produce an RC solution;
c) concentrating the RC solution at a temperature of from about 55° C. to 65° C.;
d) drying the resulting solid and liquid respectively, and thereby obtaining a crude RC extract.

8. The process of claim 7 wherein the saccharide mother liquor is formed via the steps of
a) drying Stevia leaves;
b) mixing and agitating the dried Stevia leaves with water to produce a water-leaves mixture; and
c) filtering the water-leaves mixture to obtain an aqueous filtrate

9. The process of claim 7 wherein said ultrafiltration membrane is a polyvinylidene difluoride (PVDF) wound-type membrane.

10. The process of claim 7 wherein the pore size of said ultrafiltration membrane is preferably from about 0.01-0.2 μm.

11. The process of claim 7 wherein the ultrafiltration membrane comprises a surface layer and such layer has a thickness of from about 0.03 to 0.06 μm.

12. The process of claim 7 wherein the ultrafiltration membrane comprises a surface layer and such layer has a thickness of about 0.05 μm.

13. The process of claim 7 wherein the ultrafiltration membrane comprises an underlayer and such underlayer has a thickness of from 250-350 μm.

14. The process of claim 7 wherein the ultrafiltration membrane comprises an underlayer and such underlayer has a thickness of 300 μm.

15. The process of claim 7 wherein a molecular weight cut-off of said ultrafiltration membrane is from 5500-6500 DA.

16. The process of claim 7 wherein a molecular weight cut-off of said ultrafiltration membrane is 6000 DA.

17. The process of claims 1 and 7 wherein the flow rate of said feedstock solution is preferably about 25-35 L/m2h.

18. A process for further refining the crude RC extracts prepared by the processes of claims 1 and 7, which comprises the following steps:
a) preparing a mixed solvent of an alcohol-ketone solvent solution;
b) heating the mixed solvent;
c) mixing crude RC into the mixed solvent, with a mass ratio between the mixed solvent and said crude RC of preferably about 2.0-4.0:1. more preferably 2.5-3.5:1;
d) dissolving the crude RC in the mixed solvent and forming a mixed solution,
e) cooling down said mixed solution to an ambient temperature;
f) letting the mixed solution stand with stirring at intervals; and
g) after standing, performing a solid-liquid separation, drying the resulting solid and liquid respectively, and obtaining a refined RC.

19. The process of claim 18 wherein the alcohol-ketone solvent solution comprises ethanol, methanol and acetone.

20. The process of claim 18 wherein the alcohol-ketone solvent solution comprises 85%±2% of ethanol, 70%±2% of methanol, and 85%±2% of acetone at a ratio of 3:2:1.

21. The process of claim 18 wherein, the heating at step b) is between 50-65° C.

22. The process of claim 18 wherein, the heating at step b) is to 60° C.

23. The process of claim 18 wherein, at step g), there is drying of a resulting solid and liquid through solid-liquid separation and comprises the following steps:
a) dissolving the solid into a solution with a mass concentration of 20%±2% by the addition of non-brine water;
b) concentrating the solution into a concentration of 40%±2%;
c) spray drying the concentrated solution to obtain a product;
d) evaporating the alcohol-acetone mixed solvent and excessive water from the liquid;
e) as needed, adjusting the mass concentration of the liquid to 40%±2%; and
f) drying the solution to obtain a final RC product.

24. A composition comprising RC, prepared by the process of claim 1 and at least one other steviol glycoside.

25. A composition comprising RC, prepared by the process of claim 7 and at least one other steviol glycoside.

26. A composition comprising RC, prepared by the process of claim 18 and at least one other steviol glycoside.

27. A composition comprising RC, prepared by the process of claim 23 and at least one other steviol glycoside.

28. A composition comprising RC, as prepared by at least one of the processes of claims 1, 7, 18 and 23 and at least one of Stevioside (STV), Rebaudioside A (RA), Rubusoside, Dulcoside A (DA), Rebaudioside F (RF), Rebaudioside D (RD), Steviolbioside (STB) and Rebaudioside B (RB).

29. The use of a composition comprising RC, as prepared by at least one of the processes of claims 1, 7, 18 and 23, as a amplifier to enhancer the sweetening characteristics of at least one of Stevioside (STV), Rebaudioside A (RA), Rubusoside, Dulcoside A (DA), Rebaudioside F (RF), Rebaudioside D (RD), Steviolbioside (STB) and Rebaudioside B (RB).
